(19) United States
(12) Patent Application Publication
(10) Pub. No.: US 2020/0050625 A1
(43) Pub. Date: Feb. 13, 2020

(54) VIRTUAL PRESENTATION

(71) Applicant: Hewlett-Packard Development Company, L.P., Houston, TX (US)

(72) Inventors: Marcio Bortolini, Porto Alegre (BR); Rodrigo Teles Hermeto, Porto Alegre (BR)

(21) Appl. No.: 16/334,855

(22) PCT Filed: Sep. 28, 2016
(86) PCT No.: PCT/US2016/054073

§ 371 Date: Mar. 20, 2019

(51) Int. Cl. G06F 16/44; G06T 19/00; G06F 3/01; G06F 16/188; G06F 3/0482; G06T 5/50

(52) U.S. Cl. CPC G06F 16/44; G06T 19/006; G06T 5/50; G06F 16/188; G06F 3/0482; G06F 3/011

(57) ABSTRACT

Example implementations relate to virtual presentations. For example, a system for virtual presentation may include generating a virtual presentation based on a received presentation file and a received presenting environment characteristic. The system may further include analyzing a display characteristic of the virtual presentation. The system may further include creating a presentation quality report based on the analysis.

### BACKGROUND

A presentation may include the process of delivering content regarding a topic to an audience. A presentation may include a demonstration, introduction, lecture, speech, etc. regarding the content that may inform, persuade, and/or otherwise communicate information. A presentation program may be utilized in delivering the content. A presentation program may include slide show presentation software and/or presenting hardware.

### BRIEF DESCRIPTION OF THE DRAWINGS

FIG. 1 illustrates a diagram of an example system, according to the present disclosure.

FIG. 2 illustrates a block diagram of an example system, according to the present disclosure.

FIG. 3 illustrates an example method for virtual presentation, according to the present disclosure.

### DETAILED DESCRIPTION

A presentation may include the use of a presentation program to develop, organize, deliver, and display presentation content. A presentation program may include instructions (e.g., software, etc.) and/or hardware to develop, organize, deliver, and display presentation content. For example, a presentation program may include a slide show presentation program to develop, organize, deliver, and display presentation content as individual pages or slides.

The visual appearance of a presentation as it is presented may be influenced by environmental characteristics of the presenting environment. In some examples, environmental characteristics may create an unintended or inaccurate visual appearance of the presentation as it is presented. Examples of the present disclosure may ameliorate the risk of unintended or inaccurate visual appearances during presentation by generating and analyzing a virtual presentation and creating a presentation quality report identifying potential display characteristics that may be inaccurately or unintendedly displayed utilizing environmental characteristics of the presenting environment.

Slides may contain text, graphics, sound, movies, animations, and other objects. The contents of a slide may be freely arrangeable. The contents of the slides may have various spacing, justification, color, size, shapes, etc.

The slides may be printed as handouts. The slides may be displayed on a live display such as a computer display, monitor, laptop screen, desktop screen, tablet screen, etc. The slides may be displayed as a projected display such as an image displayed on a projection screen, wall, smart board, whiteboard, glass, etc. via a video projector. The slides may be navigated through by the presenter as the presentation is delivered.

Each slide of a presentation may have a visual appearance. A visual appearance may include the appearance of the slide and its contents as perceived by a member of the audience. For example, the visual appearance of the slide may include the appearance of the slide and its contents as perceived by the human eye of a human audience member.

Various environmental characteristics of the presenting environment may influence the visual appearance of the presentation. The presenting environment may include the environment in which the content of a presentation will be displayed to or otherwise delivered to the audience. For example, the presentation environment may include a conference room where the presentation will be displayed to the audience.

Environmental characteristics of the presenting environment may include characteristics of the environment, the specifications and behavior of presenting hardware within a presenting environment, the characteristics of instructions utilized to display the content of the presentation to the audience, and/or the compatibility, relationship, and/or spacing between presenting hardware components. The environmental characteristics may include attributes that influence the visual appearance of the presentation as displayed to the audience.

Environmental characteristics may alter the visual appearance of the presentation from an intended visual appearance. For example, the presenter or architect of the presentation may have created the presentation to have an intended visual appearance. The presenter or architect of the presentation may have identified or designed the intended visual appearance under a first set of environmental characteristics. However, the presentation environment may have a second, different set of environmental characteristics that cause the presentation to be displayed in an unintended and/or undesirable manner to an audience. For example, the second set of environmental characteristics may cause the presentation to be displayed with an inaccurate or incorrect visual appearance relative to the intended visual appearance specified by the presenter or presentation architect as identified in a presentation program with a first set of environmental characteristics. An inaccurate and/or incorrect visual appearance of a presentation may obscure the content and/or message of a presentation and may negatively impact the audience experience and efficacy of the presentation.

In contrast, examples of the present disclosure may include a system for generating a presentation that will have an intended visual appearance regardless of environmental characteristics. Examples of the present disclosure may create, be utilized in creating, and/or be utilized in correcting an already created presentation such as a slide presentation to compensate for environmental characteristics resulting in an intended and/or accurate visual appearance of the slides, For example, according to the present disclosure a system may generate a virtual presentation based on a received presentation file and a received presenting environment characteristic. The system may analyze a display characteristic of the virtual presentation and create a presentation quality report based on the analysis,

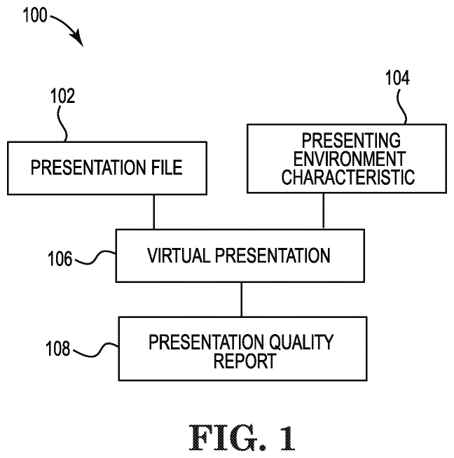

FIG. 1 illustrates a diagram of an example system 100, according to the present disclosure. As illustrated in FIG. 1, the system 100 may include a presentation file 102, a presenting environment characteristic 104, a virtual presentation 106, and a presentation quality report 108.

The presentation file 102 may include a digital file. The presentation file 102 may be a file generated at a user device, The presentation file 102 may be a slide presentation file from a presentation program. Each slide of the presentation file 102 may include elements. Elements may include objects such as text, graphics, sound, movies, text boxes, animations, etc.

Each slide of the presentation file 102 may also include display characteristics associated with the slides and/or objects. For example, display characteristics may include spacing, justification, color, size, shapes, contrast, alignment, movement parameters, etc. associated with each element on a slide. A display characteristic may refer to a characteristic that changes how a slide and/or an object on a slide is displayed when presented. For example, a display characteristic may refer to a characterization of a visual appearance of spacing, justification, color, size, shapes, contrast, alignment, movement parameters, etc. of an object and/or slide as it is perceived by the eye of an audience member.

A display characteristic may be influenced and/or altered by an environmental characteristic. A characteristic of the environment within and/or through which the presentation file 102 is displayed may influence and/or alter the elements, the display characteristics, and/or how the display characteristics are perceived by the eye of an audience member. An environmental characteristic may include a characteristic of the computing device utilized in delivering the presentation to the audience. For example, the environmental characteristic may include the specifications, model, operating system, software programs, hardware components, cabling, wireless interfaces, communication protocols, and/or add on components of a computing device utilized in delivering the presentation and the compatibility of each of those characteristics with the corresponding characteristics of other computing devices.

An environmental characteristic may include a characteristic of a display. For example, an environmental characteristic may include a characteristic of a display utilized to display the presentation. A display may include a display medium, a live display, a projected display, a projector, a video projector, a digital projector, a standalone projector, a projector integrated into a computing device, a monitor, a screen, a board, a smart board, etc. An environmental characteristic may include specifications, model, manufacturer, software programs, hardware components, cabling, wireless interfaces, communications protocols, add on components, luminance, contrast, contrast polarity, resolution, raster structure, jitter, temporal instability, refresh rate, persistence, color display, constant color, reflection characteristics, throw ratio, optical component alignment, spacing of display components, lamp type, lamp spectrum, lamp manufacturer, lamp life, hours of lamp use, condition of optical components, display settings, aspect ratio, compatibility of the display with a computing device, compatibility of the display with a presenting program, compatibility of the display with other components of a presentation system, etc. of a display utilized to display the presentation.

An environmental characteristic may include a characteristic of the presentation space. For example, an environmental characteristic may include a dimension of a space and/or room where the presentation file 102 is displayed. An environmental characteristic may include the dimensions between hardware components of a presentation system such as a computing device, a display, a projector, a projection surface (e.g., screen, board, smart board, wall, etc.), etc. For example, an environmental characteristic may include the distance between a projector projecting the presentation and a projection surface upon which the presentation is being projected. Additionally, the environmental characteristic may include the alignment of the projected image on the projection surface. For example, whether a portion of the projected image is actually projected off the side of a projection surface. The environmental characteristic may also include the dimensions (e.g., distance, elevation, angle of viewing, etc.) between the audience and the display.

An environmental characteristic may include lighting conditions and/or an illumination level in a space and/or room where the presentation file 102 is displayed, For example, an environmental characteristic may include an amount of light in an display environment coming from direct lighting, indirect lighting, sunlight, moonlight, lighting bleeding in from other environments, lighting supplied by other devices in the environment. The environmental characteristic may include the time of day of a presentation, which may correspond to an amount of lighting in a particular environment.

An environmental characteristic may include a setting. For example, an environmental characteristic may include a setting of any component of a presentation display setting or of an environmental characteristic control component. For example, the environmental characteristic may include a setting of a computing device, a presentation program, a display, a projector, a screen, a smart board, a room lighting controller, etc.

An environmental characteristic may include a presenting environment characteristic 104. A presenting environment characteristic 104 may include an environmental characteristic of the environment in which the presentation file is to be displayed and/or presented. For example, if a presentation file is to be delivered as part of a presentation in Conference Room A of a convention center, the presenting environment characteristic 104 may be an environmental characteristic of Conference Room A.

The presenting environment characteristic 104 may be generated by and/or received from a user device. In an example, the user device may be the same user device that the presentation file 102 was created on and/or received from. The presenting environment characteristic 104 may be detected by instructions and/or hardware components on the user device and/or a device in the presenting environment. The presenting environment characteristic 104 may be user input on a user device. For example, the presenting environment characteristic 104 may include user input describing specific environmental characteristics of the presenting environment and/or user input describing information about the presenting environment (e.g., a conference room name, a conference room location, a conference room address, etc.) from which specific environmental characteristics may be determined. The presenting environment characteristic 104 may include a user selection of predefined options describing specific environmental characteristics of the presenting environment and/or describing information about the presenting environment. The presenting environment characteristic 104 may be retrieved from a database and/or from a third party associated with the presenting environment that specifies specific environmental characteristics.

The presentation file 102 and/or the presenting environment characteristic 104 may be uploaded from a user device and received by a cloud based presentation simulator for analysis. The cloud based presentation simulator may utilize a server and/or distributed cloud computing resources to analyze the presentation file 102 and/or the presenting environment characteristic 104.

A virtual presentation 106 may be generated. A virtual presentation 106 may include a simulation of the presenting file 102. The virtual presentation may include a simulation of the visual appearance of the presenting file 102 when the presenting file is displayed utilizing the received presenting environment characteristic 104.

The virtual presentation 106 may be generated based on a received presentation file 102 and/or from the received presenting environment characteristic 104. For example, the virtual presentation 106 may include a simulated rendering of each slide of the presentation file 102 as it will visually appear when displayed and/or presented utilizing the presenting environment characteristic 104 and/or a cumulative utilization of a plurality of presenting environment characteristics. The virtual presentation 106 may include a simulated rendering of each display element and each display characteristic of each slide of the presentation file. Therefore, each slide and/or display element simulated in a virtual presentation 106 may include a simulated virtual display characteristic.

The display characteristics of the virtual presentation 106 may be analyzed. For example, a color analysis of each slide and/or display element simulated in the virtual presentation 106 may be analyzed. A color analysis may include an identification of a background color of a slide, a contrast between a background color of the slide, and/or a measurement of brightness of a color appearing on a slide. A color analysis may include an analysis comparing the visual appearance of a color of a slide and/or display element of the virtual presentation to the accurate and/or intended visual appearance of the color of the slide and/or display element as it visually appeared in the presentation file 102 on a user device. Therefore, a color analysis may be utilized to determine whether a color appearing on a slide of the received presentation file 102 will be accurately displayed utilizing the received presenting environment characteristic 104.

The color analysis may identify discrepancies between the visual appearance of a color in the presentation file 102 and how that color will be displayed when presented utilizing the presenting environment characteristic 104. In an example, color discrepancies between the visual appearance of the presentation file 102 and how that file will visually appeared when displayed may be determined to represent a difference that is detrimental to the audience's ability to view the presentation file. For example, if a presentation file 102 includes a light gray font on a white background, the contrast on the user device displaying the presentation file may permit a viewer to distinguish the text. However, when the same presentation is displayed in a conference room that has a high level of illumination and a projector with a high amount of hours of use, the gray text may be washed out and imperceptible to the human audience members. In such examples, the discrepancy may be determined to be a potentially detrimental color discrepancy.

The display characteristics of the virtual presentation 106 may be analyzed utilizing a placement analysis. A placement analysis may include an analysis of a display position and/or display coordinates of a display element appearing on a slide. The placement analysis may include a determination of a placement pattern (e.g., centering of a particular display element, etc.) and/or a determination as to whether display elements adhere to that pattern when displayed utilizing the presentation environment characteristic 104. The placement analysis may include a determination as to whether any display elements coincide in position and/or coordinates when displayed utilizing the presentation environment characteristic 104. The placement analysis may include comparing the accurate and/or intended visual appearance of the position and/or coordinates of a display element of the slide and/or display element as it visually appeared in the presentation file 102 on a user device with the position and/or coordinated of the display elements displayed utilizing the presenting environment characteristic 104. Therefore, a placement analysis may be utilized to determine whether a placement of a display element of a slide of the received presentation file 102 will be accurately positioned utilizing the received presenting environment characteristic 104.

The placement analysis may identify discrepancies between the visual appearance of a placement in the presentation file 102 and how that placement will visually appear when displayed and/or presented utilizing the presenting environment characteristic 104. In an example, placement discrepancies between the visual appearance of the presentation file 102 and how that file will visually appear when displayed may be determined to represent a difference that is detrimental to the audience's ability to view the presentation file. For example, if a presentation file 102 includes a display element that appears near the far edge of a slide on a user device, but when the same presentation is displayed in a conference room that has a projector that is too close to a screen and projects over the edges then the display element may not de clear and/or fully visible to human audience members since it will not appear on the screen. In such examples, the discrepancy may be determined to be a potentially detrimental positioning discrepancy.

The display characteristics of the virtual presentation 106 may be analyzed utilizing a size analysis. A size analysis may include an analysis of a size and/or relative size of a display element appearing on a slide. The size analysis may include a determination of an accurate and/or intended size and/or relative size of a display element from the presentation file. The size analysis may include a determination of the size and/or relative size of the display element when displayed utilizing the presentation environment characteristic 104. The size analysis may include comparing the accurate and/or intended visual appearance of the size of a display element with the visual appearance of the size of the display elements displayed utilizing the presenting environment characteristic 104. Therefore, a size analysis may be utilized to determine whether a size of a display element of a slide of the received presentation file 102 will be accurately sized and/or accurately sized relative to other display elements when utilizing the received presenting environment characteristic 104.

The size analysis may identify discrepancies between the visual appearance of a size in the presentation file 102 and how that size will visually appear when displayed and/or presented utilizing the presenting environment characteristic 104. In an example, size discrepancies between the visual appearance of the presentation file 102 and how that file will visually appear when displayed utilizing the presenting environment characteristic 104 may be determined to represent a difference that is detrimental to the audience's ability to view the presentation file. For example, if a presentation file 102 includes a display element including text having a twelve point font that is easily visually distinguishable on a user device at laptop use distances, but when the same presentation is displayed in a large lecture hall that has audience members positioned twenty yards away from the projector screen, a twelve point font may not appear clear and/or fully visible to human audience members since it may be too small. In such examples, the discrepancy may be determined to be a potentially detrimental sizing discrepancy. In an example, the size analysis may include identifying a font size associated with a display element and comparing the font size with a threshold font size associated with a presenting environment characteristic 104. For example, for a presenting environment have a presenting environment characteristic 104 of including audience seating more than ten yards from a display screen, a threshold font size of fourteen point may be determined and anything below that size may be determined to be detrimental to the ability of the audience to view the associated display element.

A presentation quality report 108 may be created. The presentation quality report 108 may include a report characterizing the analyzed display characteristics of the virtual presentation 106 and/or discrepancies between the display characteristics of the virtual presentation 106 and the display characteristics of the presentation file 102. The presentation quality report 108 may be based on the analysis of the display characteristics of the virtual presentation as described above.

The presentation quality report 108 may include a highlighted version of the presentation file 102 with display elements highlighted. The highlighted display elements may include the display elements that differ in visual appearance, as determined by analysis of the display characteristics of the virtual presentation 108, from the presentation file 102 as displayed on a user computing device. The highlighted elements may include display elements that are determined to be associated with a detrimental discrepancy between display characteristics of the presentation file 102 and the virtual presentation 106, The presentation quality report 108 may provide a warning regarding different appearances of display elements of a slide presentation,

The presentation quality report 108 may include information, instructions, and/or suggestions for modifying the presentation file 102. The information, instructions, and/or suggestions for modifying the presentation file 102 may include information, instructions, and/or instructions of hose to correct an undesired visual appearance of a display element as identified by analysis of the virtual presentation 106. For example, the presentation quality report 108 may include instructions for re-coloring, re-positioning, and re-sizing display elements of the presentation file 102 to give the display elements the accurate and/or intended visual appearance when displayed utilizing the presenting environment characteristic 104.

The presentation quality report 108 may include a corrected and/or revised version of the presentation file 102. A corrected and/or revised version of the presentation file 102 may include a version of the presentation file 102 that has been modified to give display elements an intended and/or accurate visual appearance when the presentation file 102 is displayed utilizing the presenting environment characteristic 104.

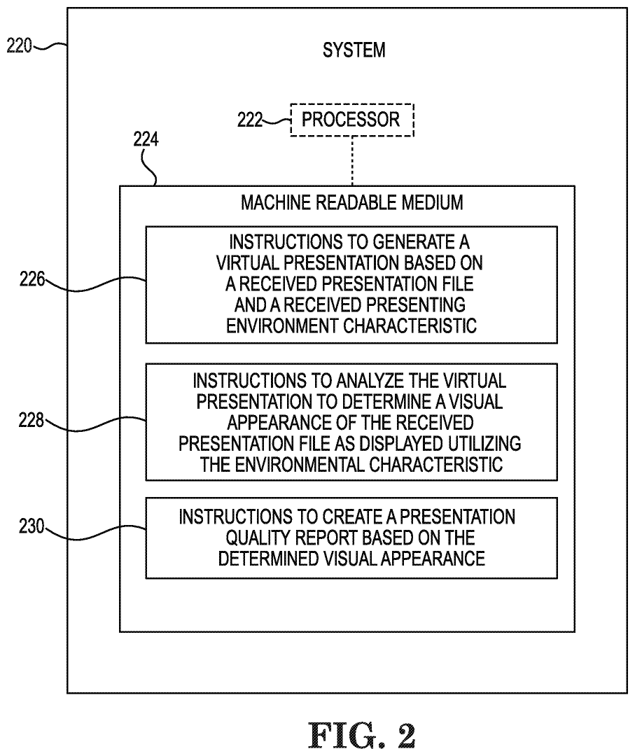

FIG. 2 is a block diagram of an example system 220 for virtual presentation, according to the present disclosure. System 220 may be the same as or different than, the system 100 illustrated in FIG. 1. System 220 may include at least one computing device that is capable of communicating with at least one remote system. In the example of FIG. 2, system 220 includes a processor 222 and a machine-readable medium 224. Although the following descriptions refer to a single processor and a single machine-readable medium, the descriptions may also apply to a system with multiple processors and machine-readable mediums. In such examples, the instructions may be distributed (e.g., stored) across multiple machine-readable mediums and the instructions may be distributed (e.g., executed by) across multiple processors.

Processor 222 may be a single or a plurality of central processing units (CPUs), microprocessors, and/or other hardware devices suitable for retrieval and execution of instructions stored in machine-readable medium 224. In the particular example shown in FIG. 2, processor 222 may receive, determine, and send instructions 226, 228, and 230 for virtual presentation. As an alternative or in addition to retrieving and executing instructions, processor 222 may include a single or a plurality of electronic circuits comprising a number of electronic components for performing the functionality of a single or a plurality of the instructions in machine-readable medium 224. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable medium 224 may be any electronic, magnetic, optical, or other physical storage device that stores executable instructions. Thus, machine-readable medium 224 may be, for example, Random Access Memory (RAM), an Electrically-Erasable Programmable Read-Only Memory (EEPROM), a storage drive, an optical disc, and the like. Machine-readable medium 224 may be disposed within system 220, as shown in FIG. 2. In this situation, the executable instructions may be “installed” on the system 220. Additionally and/or alternatively, machine-readable medium 224 may be a portable, external or remote storage medium, for example, that allows system 220 to download the instructions from the portable/external/remote storage medium. In this situation, the executable instructions may be part of an “installation package”. As described herein, machine-readable medium 224 may be encoded with executable instructions for virtual presentation.

Referring to FIG. 2, instructions 226, when executed by a processor (e.g., 222), may cause system 220 to generate a virtual presentation. The virtual presentation may be generated based on a presentation file and a presenting environment characteristic. The presentation file and the presenting environment may be received from a user computing device and/or a computing device in a presenting environment.

The environmental characteristic may include a specification of a display device to be utilized to display the received presentation file. For example, the environmental characteristic may include a make, model, and/or manufacturer of a specific display device such as a projector to be utilized in delivering the presentation.

The environmental characteristic may include a specification of an illumination level of an environment to be utilized to display the received presentation, For example, the environmental characteristic may include an illumination level selected from among a scale of illumination (e.g., brightly lit, medium lighting, dimly lit, dark, etc.) to characterize the illumination of the presenting environment.

The environmental characteristic may include a dimension of the presenting environment and between components of the presentation display system within the presenting environment. For example, the environmental characteristic may include a distance between a projector and a screen to be utilized to display the received presentation file in the presenting environment.

Instructions 228, when executed by a processor 222 may cause system 220 to analyze the virtual presentation. The virtual presentation may be analyzed to determine a visual appearance of the received presentation file as displayed utilizing the environmental characteristic. For example, the virtual presentation may include a simulated rendering of the visual appearance of the received presentation file as displayed utilizing the environmental characteristic.

Instructions 230, when executed by a processor 222 may cause system 220 to create a presentation quality report. The presentation quality report may be based on the determined visual appearance. The presentation quality report may be transmitted to a user computing device whence the presentation file and/or the environmental characteristic was received. The presentation quality report may include suggested modifications and/or corrections to the presentation file that will result in an accurate and/or intended visual appearance of display elements of the presentation file when displayed utilizing the presenting environment characteristic.

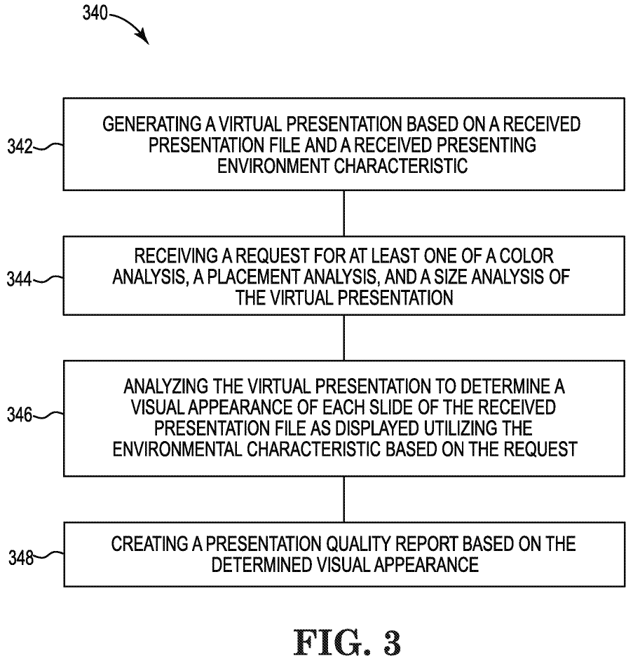

FIG. 3 illustrates an example method 340 for printing zone coordination, according to the present disclosure. At 342, the method 340 includes generating a virtual presentation. Generating a virtual presentation may include providing a user-selectable set of presenting environment characteristics to a user computing device. The user selection from the set may be received as a presenting environment characteristic. The virtual presentation may be generated based on a received presentation file and a received presenting environment characteristic.

At 344, the method 340 includes receiving a request for an analysis of the virtual presentation. For example, a request may be received from a user computing device for a particular analysis of the virtual presentation. In this manner, the identity of the analysis performed on the virtual presentation may be defined by the received requests. For example, a request may be received for a color analysis, a placement analysis, and/or a size analysis of the virtual presentation.

At 346, the method 340 includes analyzing the virtual presentation. The analysis of the virtual presentation may be utilized to determine a visual appearance of each slide of a received presentation file as displayed utilizing the environmental characteristic. The scope of the analysis may be based on the request. For example, those analyses specified in the received request may be the analyses that are performed.

At 348, the method 340 includes creating a presentation quality report. The presentation quality report may be based on the determined visual appearance. The presentation quality report may be transmitted to a user computing device from which the received presentation file was received. The presentation quality report may include suggestions for modifying the received presentation file to correct an identified undesired visual appearance when displayed utilizing the presenting environment characteristic. The presentation quality report may include a revised version of the received presentation file correcting undesired visual appearances present when displaying the presentation utilizing the presenting environment characteristic.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein,” an element and/or feature can refer to a single or a plurality of such elements and/or features.

What is claimed:

1. A system, comprising:
a virtual presentation engine to generate a virtual presentation based on a received presentation file and a received presenting environment characteristic;
a display characteristic engine to analyze a display characteristic of the virtual presentation; and
a quality report engine to create a presentation quality report based on the analysis.

2. The system of claim 1, wherein the display characteristic engine performs a color analysis of a color appearing on a slide of the received presentation file to determine whether the color will be accurately displayed utilizing the received presenting environment characteristic.

3. The system of claim 2, wherein the color analysis includes measuring a background color of the slide, measuring a contrast between the background color and the color appearing on the slide, and measuring a brightness of the color appearing on the slide.

4. The system of claim 1, wherein the display characteristic engine performs a placement analysis of a plurality of elements appearing on a slide of the received presentation file to determine whether the element will be displayed in an accurate position as displayed utilizing the received presenting environment characteristic.

5. The system of claim 4, wherein the placement analysis includes identifying a positioning pattern of the plurality of elements and identifying whether any of the plurality of elements coincide as displayed utilizing the received presenting environment characteristic.

6. The system of claim 1, wherein the display characteristic engine performs a size analysis of an element appearing on a slide of the received presentation file to determine whether the element will be displayed as an accurate size as displayed utilizing the received presenting environment characteristic.

7. The system of claim 6, wherein performing the size analysis includes identifying a font size associated with the element and comparing the font size with a threshold font size.

8. A non-transitory computer-readable medium containing instructions executable by a processor to cause the processor to:
generate a virtual presentation based on a received presentation file and a received presenting environment characteristic;
analyze the virtual presentation to determine a visual appearance of the received presentation file as displayed utilizing the environmental characteristic; and
create a presentation quality report based on the determined visual appearance.

9. The medium of claim 8, wherein the environmental characteristic includes a specification of a display device to be utilized to display the received presentation file.

10. The medium of claim 8, wherein the environmental characteristic includes an illumination level of an environment to be utilized to display the received presentation file.

11. The medium of claim 8, wherein the environmental characteristic includes a distance between a projector and a screen to be utilized to display the received presentation file.

12. A method, comprising:
generating a virtual presentation based on a received presentation file and a received presenting environment characteristic;
receiving a request for at least one of a color analysis, a placement analysis, and a size analysis of the virtual presentation;
analyzing the virtual presentation to determine a visual appearance of each slide of the received presentation file as displayed utilizing the environmental characteristic based on the request; and
creating a presentation quality report based on the determined visual appearance.

13. The method of claim 12, comprising providing a user-selectable set of presenting environment characteristics and wherein the received presenting environment characteristic is selected from the set.

14. The method of claim 12, comprising transmitting the presentation quality report to a device from which the received presentation file was received, wherein the presentation quality report includes suggestions for modifying the received presentation to correct an undesired visual appearance identified

15. The method of claim 12, comprising transmitting the presentation quality report to a device from which the received presentation file was received, wherein the presentation quality report includes a revised version of the received presentation file correcting an undesired visual appearance.
